(19) United States
(12) Patent Application Publication
(10) Pub. No.: US 2024/0328625 A1
(43) Pub. Date: Oct. 3, 2024

(54) GAS TURBINE COMBUSTOR AND GAS TURBINE

(71) Applicant: MITSUBISHI HEAVY INDUSTRIES, LTD., Tokyo (JP)

(72) Inventors: Hiroaki NAGAHASHI, Kanagawa (JP); Yoshitaka TERADA, Kanagawa (JP); Shota IGARASHI, Kanagawa (JP)

(21) Appl. No.: 18/578,124

(22) PCT Filed: Jun. 29, 2022
(86) PCT No.: PCT/JP2022/025895

§ 371 Date: Jan. 10, 2024

(30) Foreign Application Priority Data
Aug. 5, 2021 (JP) 2021-129058

(51) Int. Cl. F23R 3/28

(52) U.S. Cl. CPC F23R 3/28

(57) ABSTRACT

The gas turbine combustor according to at least one embodiment of the present disclosure comprises a burner and fuel piping that supplies fuel to the burner. The fuel piping is connected to a member that separates at least a portion of a fuel cavity from the outside of the gas turbine combustor. The fuel piping includes a first region that is positioned upstream of the member, a second region that fits into a through hole that is formed in the member and allows the fuel cavity to communicate with the outside, and a third region that has an outer circumferential surface that is separated from an inner circumferential surface of the through hole toward the inside in the radial direction. A downstream end of the fuel piping reaches an end part of the through hole that, of either end part of the through hole, is closer to the fuel cavity.

### TECHNICAL FIELD

The present disclosure relates to a gas turbine combustor and a gas turbine.

The present application claims priority based on Japanese Patent Application No. 2021-129058 filed in Japan on Aug. 5, 2021, the contents of which are incorporated herein by reference.

### BACKGROUND ART

In a gas turbine combustor in an industrial gas turbine, combustion air is compressed by a compressor configured to integrally rotate coaxially with a turbine, and is supplied to the gas turbine combustor (for example, PTL 1).

### CITATION LIST

Patent Literature

[PTL 1] Japanese Unexamined Patent Application Publication No. 2003-148734

### SUMMARY OF INVENTION

### Technical Problem

As disclosed in the above-described patent literature, a temperature of the combustion air supplied to the gas turbine combustor is relatively high, since the combustion air is compressed by the compressor. In contrast, a temperature of a fuel supplied to the gas turbine combustor is generally a room temperature. Therefore, in some of components forming the gas turbine combustor, there is a possibility that excessive thermal stress caused by a temperature difference between the combustion air and the fuel acts on the components.

At least one embodiment of the present disclosure aims to suppress thermal stress acting on the gas turbine combustor in view of the above-described circumstances.

### Solution to Problem

(1) According to at least one embodiment of the present disclosure, there is provided a gas turbine combustor including a burner, and a fuel pipe that supplies a fuel to the burner.

In the gas turbine combustor, the fuel pipe is connected to a member that partitions at least a portion of a fuel cavity and an outside of the gas turbine combustor, and includes a first region located on an upstream side of the member, a second region formed in the member and fitted to a through-hole through which the outside and the fuel cavity communicate with each other, and a third region having an outer peripheral surface separated inward in a radial direction from an inner peripheral surface of the through-hole.

A downstream end of the fuel pipe reaches an end portion closer to the fuel cavity in both end portions of the through-hole.

(2) According to at least one embodiment of the present disclosure, there is provided a gas turbine including the gas turbine combustor having a configuration of (1) above.

### Advantageous Effects of Invention

According to at least one embodiment of the present disclosure, thermal stress acting on the gas turbine combustor can be suppressed.

### BRIEF DESCRIPTION OF DRAWINGS

FIG. 1 illustrates a schematic configuration of a gas turbine including a gas turbine combustor according to some embodiments of the present disclosure.

FIG. 2 is a partial view illustrating a cluster burner structure in the gas turbine combustor according to some embodiments provided in the gas turbine illustrated in FIG. 1.

FIG. 3 is an external perspective view of an end cover according to some embodiments.

FIG. 4 is an external view when the end cover according to some embodiments is viewed from an upstream side toward a downstream side along an axial direction of the gas turbine combustor.

FIG. 5 is a view schematically illustrating a cross section taken along an arrow line A-A in FIG. 4.

FIG. 6A is a view illustrating a structure of a portion B surrounded by a broken line in FIG. 5 with regard to the gas turbine combustor according to an embodiment.

FIG. 6B is a view illustrating a structure of the portion B surrounded by the broken line in FIG. 5 with regard to a gas turbine combustor according to another embodiment.

FIG. 6C is a view illustrating a structure of the portion B surrounded by the broken line in FIG. 5 with regard to a gas turbine combustor according to still another embodiment.

FIG. 7 is a view illustrating an example of a structure of a portion corresponding to the portion B surrounded by the broken line in FIG. 5 in a gas turbine combustor in the related art.

### DESCRIPTION OF EMBODIMENTS

Hereinafter, some embodiments of the present disclosure will be described with reference to the accompanying drawings. However, dimensions, materials, shapes, and relative dispositions of components described as the embodiments or illustrated in the drawings are not intended to limit the scope of the present disclosure, and are merely examples for describing the present disclosure.

For example, expressions representing relative or absolute dispositions such as “in a certain direction”, “along a certain direction”, “parallel”, “orthogonal”, “center”, “concentric”, or “coaxial” not only strictly represent the dispositions, but also represent a state where the dispositions are relatively displaced with a tolerance or at an angle or a distance to such an extent that the same function can be obtained.

For example, expressions representing that things are in an equal state such as “same”, “equal”, and “homogeneous” not only strictly represent an equal state, but also represent a state where a difference exists with a tolerance or to such an extent that the same function can be obtained.

For example, expressions representing shapes such as a quadrangular shape and a cylindrical shape not only represent shapes such as a quadrangular shape and a cylindrical shape in a geometrically strict sense, but also represent shapes including an uneven portion or a chamfered portion within a range where the same effect can be obtained.

In addition, expressions of “being provided with”, “being equipped with”, “including”, or “having” one component are not exclusive expressions excluding the presence of other components.

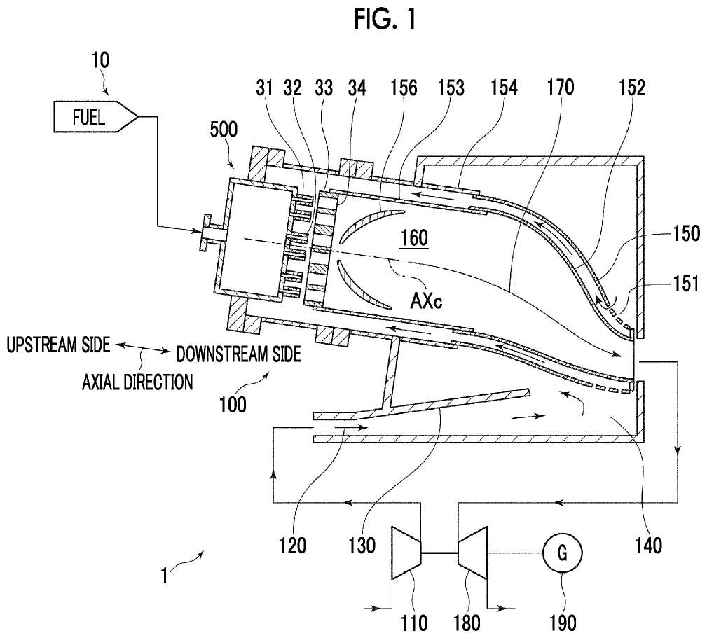

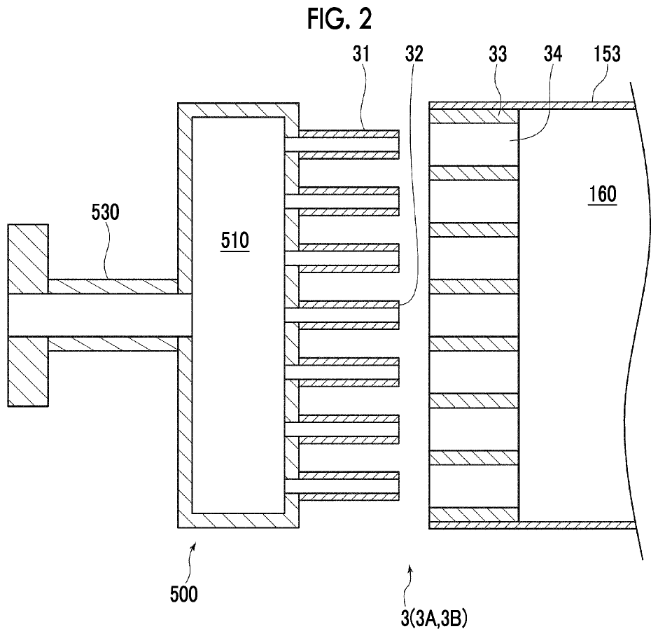

A gas turbine combustor according to some embodiments of the present disclosure will be described with reference to FIGS. 1 and 2.

FIG. 1 illustrates a schematic configuration of a gas turbine including a gas turbine combustor according to some embodiments of the present disclosure. In a gas turbine 1 illustrated in FIG. 1, high-pressure air 120 which is combustion air discharged from an air compressor 110 is introduced into a casing 140 from a diffuser 130, and flows into a flow path formed in a gap between a transition piece flow sleeve 150 and a transition piece 152 disposed inside the transition piece flow sleeve 150 from an air introduction hole 151 provided in the transition piece flow sleeve 150 of a gas turbine combustor 100.

Thereafter, the high-pressure air 120 flowing into the flow path formed in the gap flows into the flow path formed in a gap between a liner 153 of the gas turbine combustor 100 and a liner flow sleeve 154 disposed concentrically with the liner 153 on an outer peripheral side of the liner 153. Thereafter, a flow of the high-pressure air 120 is reversed and introduced from a fuel supply unit 10. The high-pressure air 120 is mixed with a fuel injected from a plurality of fuel nozzles 31 and 32 forming a cluster nozzle, and is combusted in a combustion chamber 160 inside the liner 153 to form a flame 156 and to generate a high-temperature and high-pressure combustion gas 170.

In this way, the high-temperature and high-pressure combustion gas 170 generated in the gas turbine combustor 100 flows down in the transition piece 152, and is introduced into a turbine 180.

In the turbine 180 forming the gas turbine 1, a work amount generated when the high-temperature and high-pressure combustion gas 170 introduced into the turbine 180 is subjected to adiabatic expansion is converted into a shaft rotational force by the turbine 180. In this manner, an output is obtained from a generator 190 by driving the generator 190 connected to the turbine 180 by a turbine shaft.

The air compressor 110 and the generator 190 which form the gas turbine 1 are connected to the turbine 180 by the turbine shaft. However, the air compressor 110, the turbine 180, and the generator 190 may not have a configuration in which the turbine shaft has a single shaft, and may have a configuration in which the turbine shaft has two or more shafts.

In addition, the gas turbine which is generally widely used in a thermal power plant has a configuration in which a plurality of the gas turbine combustors are radially arranged with respect to the turbine shaft.

FIG. 2 is a partial view illustrating a cluster burner structure in the gas turbine combustor 100 according to some embodiments provided in the gas turbine 1 illustrated in FIG. 1.

The gas turbine combustor 100 according to some embodiments includes an end cover 500, a plurality of fuel nozzles 31 and 32 attached to the end cover 500 to form a cluster nozzle, and an air hole plate 33.

The end cover 500 has a fuel cavity forming portion 501 forming a plurality of fuel cavities 510, and a plurality of fuel pipes 530. In FIG. 2, a structure of the end cover 500 is illustrated in a simplified manner, and only one fuel cavity 510 and only one fuel pipe 530 are respectively illustrated. The structure of the end cover 500 will be described in detail later.

The fuel supplied to the cluster burner in the gas turbine combustor 100 through the fuel supply unit 10 is supplied from the fuel supply unit 10 to the fuel cavity 510 provided in the end cover 500 of the gas turbine combustor 100.

The cluster burner is provided with the plurality of fuel nozzles 31 and 32, and the plurality of fuel nozzles 31 and 32 are respectively disposed coaxially with a plurality of air holes 34 to have a one-to-one correspondence with the plurality of air holes 34 formed in the air hole plate 33 disposed close to a downstream side of the fuel nozzles 31 and 32.

The fuel injected from the plurality of fuel nozzles 31 and 32 toward the plurality of air holes 34 formed in the air hole plate 33 is jetted to the combustion chamber 160 together with the combustion air supplied from the air compressor 110, and is rapidly mixed and combusted to form a flame and to generate the high-temperature and high-pressure combustion gas 170.

In the gas turbine combustor 100 according to some embodiments, the used fuel is a gaseous fuel, but using a liquid fuel is not excluded.

In the following description, the gas turbine combustor 100 will also be simply referred to as the combustor 100.

### End Cover 500

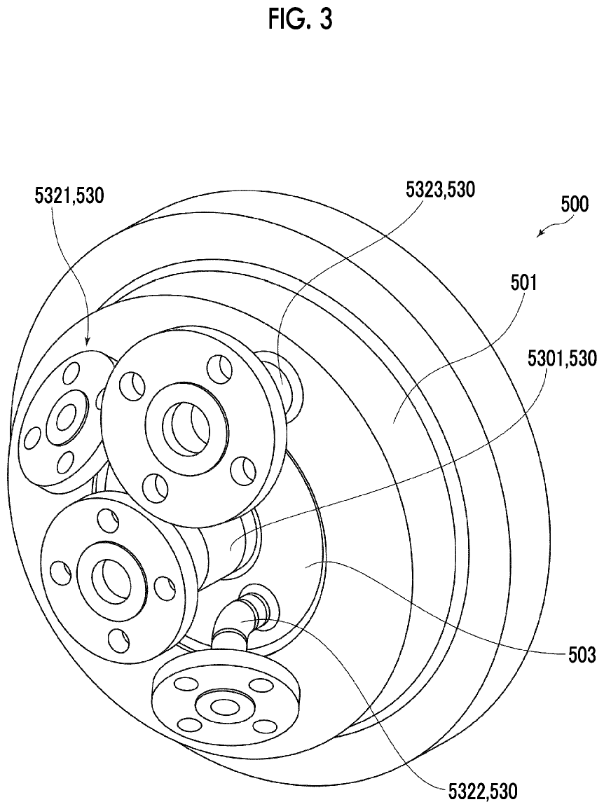

FIG. 3 is an external perspective view of the end cover 500 according to some embodiments.

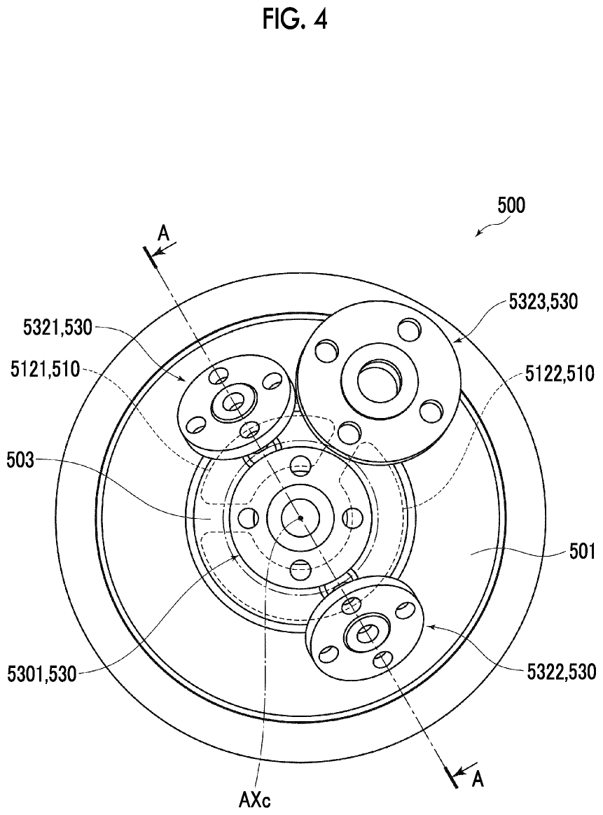

FIG. 4 is an external view when the end cover 500 according to some embodiments is viewed from an upstream side toward a downstream side along a direction of an axis (central axis AXc) of the gas turbine combustor 100.

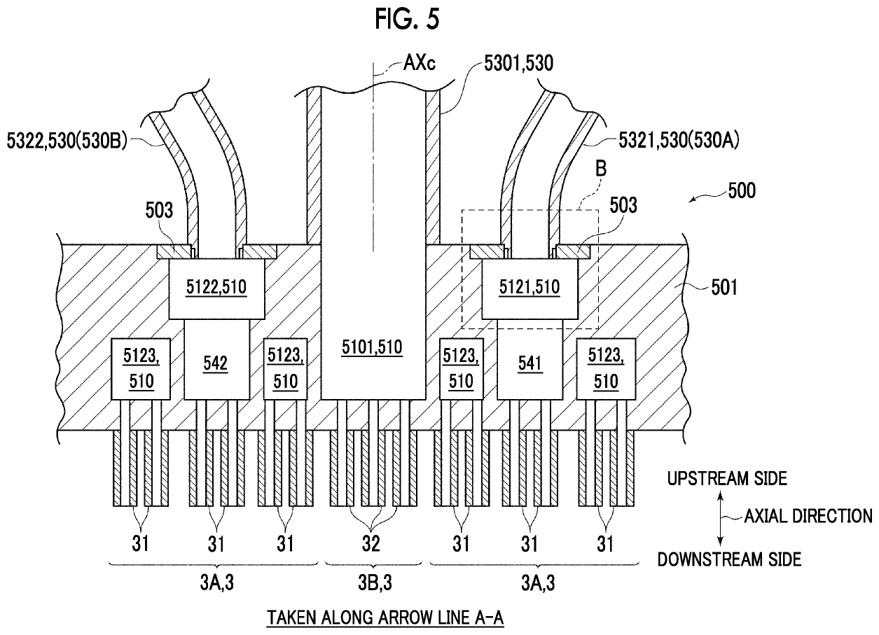

FIG. 5 is a view schematically illustrating a cross section taken along an arrow line A-A in FIG. 4.

As described above, the end cover 500 according to some embodiments has the fuel cavity forming portion 501 forming the plurality of fuel cavities 510 and the plurality of fuel pipes 530.

The end cover 500 according to some embodiments has an F1 system fuel cavity 5101, an F21 system fuel cavity 5121, an F22 system fuel cavity 5122, and an F23 system fuel cavity 5123 inside the fuel cavity forming portion 501.

The F1 system fuel cavity 5101 extends along the central axis AXc at a center position in a radial direction around the central axis AXc of the combustor 100. An F1 system fuel pipe 5301 is connected to the F1 system fuel cavity 5101. In addition, the plurality of fuel nozzles 32 are connected to the F1 system fuel cavity 5101.

In the following description, a direction along the central axis AXc of the combustor 100 will be referred to as an axial direction of the combustor 100, or will be simply referred to as an axial direction. A direction in which the combustion gas 170 flows along the axial direction will be referred to as an axial downstream side, or will be simply referred to as a downstream side. A direction opposite to a flow of the combustion gas 170 will be referred to as an axial upstream side, or will be simply referred to as an upstream side.

The F21 system fuel cavity 5121 is the fuel cavity 510 extending along a circumferential direction around the central axis AXc of the combustor 100 and having a partially annular shape when viewed along the central axis AXc.

The F21 system fuel cavity 5121 is covered with a lid member 503 from the axial upstream side.

An F21 system fuel pipe 5321 for supplying the fuel to the F21 system fuel cavity 5121 is connected to the F21 system fuel cavity 5121. The F21 system fuel pipe 5321 is attached to the lid member 503.

A plurality of fuel distribution flow paths 541 for distributing the fuel inside the F21 system fuel cavity 5121 are formed in the fuel cavity forming portion 501. Each end portion on the axial upstream side of the plurality of fuel distribution flow paths 541 is connected to the axial downstream side of the F21 system fuel cavity 5121.

In each of the plurality of fuel distribution flow paths 541, the plurality of fuel nozzles 31 are connected to one fuel distribution flow path 541 on the axial downstream side.

The F22 system fuel cavity 5122 is the fuel cavity 510 extending along the circumferential direction around the central axis AXc of the combustor 100 and having a partially annular shape when viewed along the central axis AXc.

The F22 system fuel cavity 5122 is covered with the lid member 503 from the axial upstream side.

An F22 system fuel pipe 5322 for supplying the fuel to the F22 system fuel cavity 5122 is connected to the F22 system fuel cavity 5122. The F22 system fuel pipe 5322 is attached to the lid member 503.

A plurality of fuel distribution flow paths 542 for distributing the fuel inside the F22 system fuel cavity 5122 are formed in the fuel cavity forming portion 501. In each of the plurality of fuel distribution flow paths 542, an end portion on the axial upstream side is connected to the axial downstream side of the F22 system fuel cavity 5122.

In each of the plurality of fuel distribution flow paths 542, the plurality of fuel nozzles 31 are connected to one fuel distribution flow path 542 on the axial downstream side.

The F23 system fuel cavity 5123 is the fuel cavity 510 extending along the circumferential direction around the central axis AXc of the combustor 100.

An F23 system fuel pipe 5323 (refer to FIG. 3) for supplying the fuel to the F23 system fuel cavity 5123 is connected to the F23 system fuel cavity 5123.

The plurality of fuel nozzles 31 are connected to the F23 system fuel cavity 5123.

In some embodiments, the gas turbine combustor 100 is the gas turbine combustor 100 including a burner 3 and the fuel pipe 530 that supplies the fuel to the burner 3.

In some embodiments, the burner (cluster burner) 3 is formed by the plurality of fuel nozzles 31, the plurality of fuel nozzles 32, and the air hole plate 33.

In some embodiments, the plurality of fuel nozzles 31 connected to the F21 system fuel cavity 5121, the F22 system fuel cavity 5122, and the F23 system fuel cavity 5123 form a main burner 3A.

In some embodiments, the plurality of fuel nozzles 32 connected to the F1 system fuel cavity 5101 form a pilot burner 3B.

### Regarding Partial Load Operation

The gas turbine combustor 100 according to some embodiments is configured so that the fuel is supplied to all of the fuel cavities 510, and the fuel is injected from all of the fuel nozzles 31 and 32 during a rated load operation.

In addition, the gas turbine combustor 100 according to some embodiments is configured so that the fuel is supplied to only some of the fuel cavities 510, and the fuel is injected from some of the fuel nozzles 31 and 32 during a partial load operation.

In addition, when a load increases from a state where the fuel is supplied only to the F1 system fuel cavity 5101, the gas turbine combustor 100 according to some embodiments is configured so that, for example, first, the fuel is also supplied to the F21 system fuel cavity 5121, and the high-pressure air 120 is supplied from the fuel pipe 530 to the F22 system fuel cavity 5122 and the F23 system fuel cavity 5123.

When the load further increases, the gas turbine combustor 100 according to some embodiments is configured so that, for example, the fuel is also supplied to the F22 system fuel cavity 5122, and the high-pressure air 120 is supplied from the fuel pipe 530 to the F23 system fuel cavity 5123.

When the load further increases, the gas turbine combustor 100 according to some embodiments is configured so that, for example, the fuel is also supplied to the F23 system fuel cavity 5123.

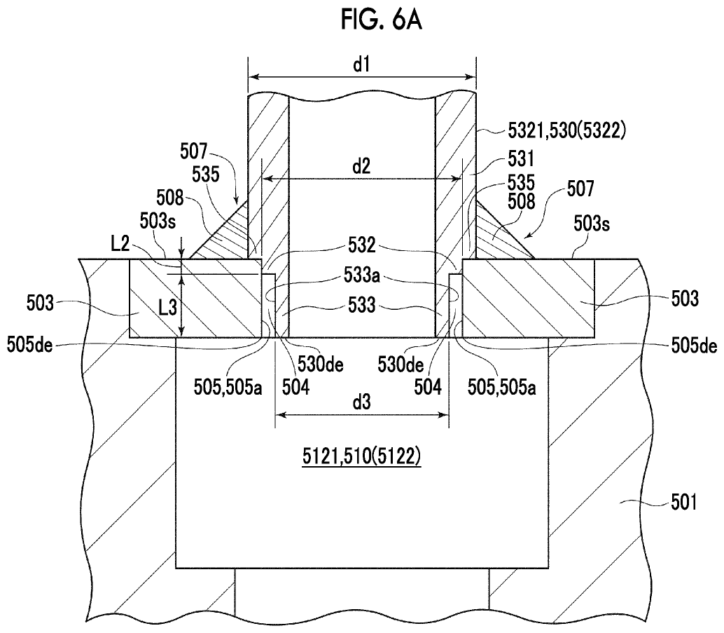

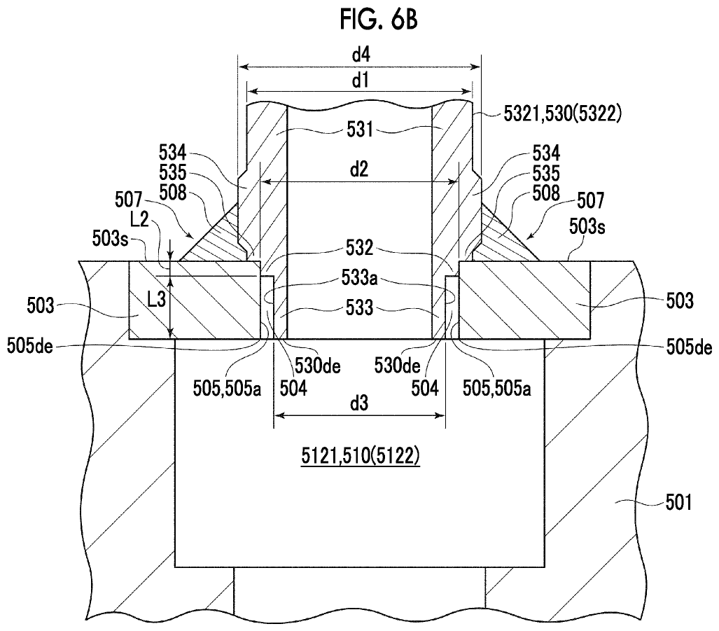

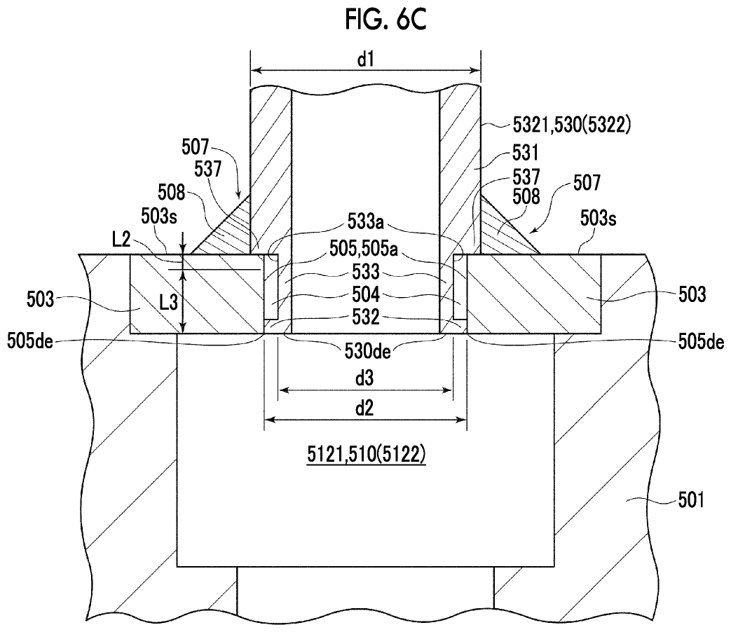

FIG. 6A is a view illustrating a structure of a portion B surrounded by a broken line in FIG. 5 with regard to the gas turbine combustor 100 according to the embodiment.

FIG. 6B is a view illustrating a structure of the portion B surrounded by the broken line in FIG. 5 with regard to the gas turbine combustor 100 according to another embodiment.

FIG. 6C is a view illustrating a structure of the portion B surrounded by the broken line in FIG. 5 with regard to the gas turbine combustor 100 according to still another embodiment.

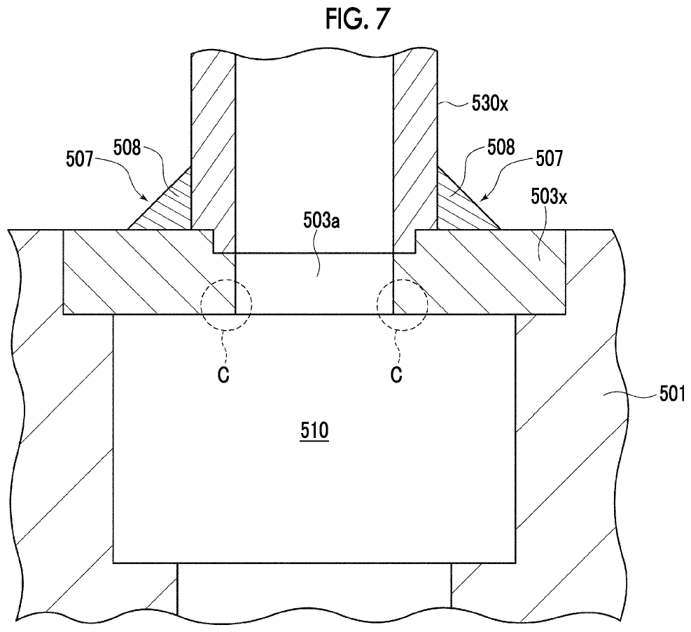

FIG. 7 is a view illustrating an example of a structure of a portion corresponding to the portion B surrounded by the broken line in FIG. 5 in a gas turbine combustor in the related art.

As described above, the gas turbine combustor 100 according to some embodiments is configured so that the high-pressure air 120 is supplied from the fuel pipe 530 to some of the fuel cavities 510 during the partial load operation. Since the high-pressure air 120 is compressed by the air compressor 110, the high-pressure air 120 has a relatively high temperature.

Therefore, when the high-pressure air 120 is supplied from the fuel pipe 530 to some of the fuel cavities 510, the fuel cavity forming portion 501 defining the fuel cavities 510 and the lid member 503 are heated.

In contrast, for example, the fuel has a room temperature of approximately 40° C. Therefore, in the gas turbine combustor in the related art, for example, when the fuel having the room temperature is supplied to the fuel cavity 510 via a fuel pipe 530X illustrated in FIG. 7, a hole portion 503a configured so that the fuel circulates in a lid member 503X is cooled by the fuel, and relatively high thermal stress acts on an inner peripheral edge portion of the hole portion 503a, that is, a region C surrounded by a broken line in FIG. 7.

Therefore, in the gas turbine combustor 100 according to some embodiments, the fuel pipe 530 is connected to a member that partitions at least a portion of the fuel cavity 510 and the outside of the gas turbine combustor 100. Specifically, as illustrated in FIGS. 6A, 6B, and 6C, the fuel pipe 530 (F21 system fuel pipe 5321) is connected to the lid member 503, which is the member that partitions at least a portion of the fuel cavity 510 and the outside of the gas turbine combustor 100.

In the gas turbine combustor 100 according to some embodiments, the fuel pipe 530 (F21 system fuel pipe 5321) includes a first region 531 located on the upstream side of the member (lid member 503), a second region 532 formed in the member (lid member 503) and fitted to a through-hole 505 through which the outside and the fuel cavity 510 (F21 system fuel cavity 5121) communicate with each other, and a third region 533 having an outer peripheral surface 533a separated inward in the radial direction from an inner peripheral surface 505a of the through-hole 505. A downstream end 530de of the fuel pipe 530 (F21 system fuel pipe 5321) reaches an end portion 505de closer to the fuel cavity 510 in both end portions of the through-hole 505.

According to the gas turbine combustor 100 illustrated in FIGS. 6A, 6B, and 6C, the outer peripheral surface 533a of the third region 533 is separated inward in the radial direction from the inner peripheral surface 505a of the through-hole 505 formed in the member (lid member 503a) that partitions at least a portion of the fuel cavity 510 and the outside of the gas turbine combustor 100. Therefore, an empty space 504 between the outer peripheral surface 533a of the third region 533 and the inner peripheral surface 505a of the through-hole 505 functions as a heat shield layer. In this manner, compared to when the outer peripheral surface 533a of the third region 533 is in contact with the inner peripheral surface 505a of the through-hole 505, the member (lid member 503) is less likely to be locally cooled by the fuel, and thermal stress of the member (lid member 503) can be reduced. In addition, the downstream end 530de of the fuel pipe 530 (F21 system fuel pipe 5321) reaches the end portion 505de closer to the fuel cavity 510 in the through-hole 505. Therefore, a possibility that the fuel is locally cooled by directly coming into contact with the member (lid member 503) inside the through-hole 505 is suppressed, and the thermal stress of the member (lid member 503) can be reduced.

Therefore, according to the gas turbine combustor 100 illustrated in FIGS. 6A, 6B, and 6C, durability of the gas turbine combustor 100 can be improved.

In the gas turbine combustor 100 illustrated in FIGS. 6A, 6B, and 6C, the F22 system fuel pipe 5322 may have the same configuration as that of the F21 system fuel pipe 5321 described above.

Since the gas turbine according to the embodiment includes the gas turbine combustor 100 having the above-described configuration, the thermal stress of the member (lid member 503) can be reduced, and the durability of the gas turbine combustor 100 can be improved. Therefore, reliability of the gas turbine 1 can be improved.

In the gas turbine combustor 100 illustrated in FIGS. 6A and 6B, a first outer diameter d1 of the first region 531 may be larger than a second outer diameter d2 of the second region 532. The fuel pipe 530 may have a step portion 535 formed by a difference between the first outer diameter d1 and the second outer diameter d2 at a boundary portion between the first region 531 and the second region 532. The step portion 535 may come into contact with an outer surface 503s of the member (lid member 503).

In this manner, the step portion 535 comes into contact with the outer surface of the member (lid member 503) that partitions at least a portion of the fuel cavity 510 and the outside of the gas turbine combustor 100, and the second region 532 is fitted to the through-hole 505 as in the above-described configuration. Therefore, the fuel pipe 530 (F21 system fuel pipe 5321) and the member (lid member 503) are fitted in a spigot joint manner. In this manner, it becomes easier to perform positioning when the fuel pipe 530 (F21 system fuel pipe 5321) is attached to the member (lid member 503). In addition, a position of the through-hole 505 in the radial direction inside the through-hole 505 of the third region 533 is determined by the fitting in the spigot joint manner. Therefore, a possibility that a gap between the outer peripheral surface 533a of the third region 533 and the inner peripheral surface 505a of the through-hole 505 varies depending on a position in the circumferential direction is suppressed.

In the gas turbine combustor 100 illustrated in FIGS. 6A and 6B, the F22 system fuel pipe 5322 may have the same configuration as that of the F21 system fuel pipe 5321 described above.

In the gas turbine combustor 100 illustrated in FIGS. 6A and 6B, the third region 533 may be located on the downstream side (axial downstream side) of the fuel pipe 530 (F21 system fuel pipe 5321) with respect to the second region 532. That is, in the gas turbine combustor 100 illustrated in FIGS. 6A and 6B, in the fuel pipe 530 (F21 system fuel pipe 5321), the first region 531, the second region 532, and the third region 533 are disposed from the upstream side toward the downstream side in this order.

In this manner, compared to when the third region 533 is located on the upstream side of the fuel pipe 530 (F21 system fuel pipe 5321) with respect to the second region 532, the position of the third region 533 is closer to the fuel cavity 510. Therefore, a region relatively closer to the fuel cavity 510 in the member (lid member 503) that partitions at least a portion of the fuel cavity 510 and the outside of the gas turbine combustor 100 is less likely to be cooled by the fuel.

The member (lid member 503) partitions at least a portion of the fuel cavity 510 and the outside of the gas turbine combustor 100. Therefore, a region closer to the fuel cavity 510 tends to have a higher temperature than a region farther from the fuel cavity 510. That is, in the member (lid member 503), the region on the downstream side of the fuel pipe 530 (F21 system fuel pipe 5321) tends to have a higher temperature than the region on the upstream side. Therefore, according to the gas turbine combustor 100 illustrated in FIGS. 6A and 6B, as described above, the region relatively closer to the fuel cavity 510 in the member (lid member 503) is less likely to be locally cooled by the fuel. Therefore, the thermal stress of the member (lid member 503) can be effectively reduced.

In the gas turbine combustor 100 illustrated in FIGS. 6A and 6B, the F22 system fuel pipe 5322 may have the same configuration as that of the F21 system fuel pipe 5321 described above.

In the gas turbine combustor 100 illustrated in FIG. 6C, the first outer diameter d1 of the first region 531 may be larger than a third outer diameter d3 of the third region 533. The fuel pipe 530 may have a step portion 537 formed by a difference between the first outer diameter d1 and the third outer diameter d3 at the boundary portion between the first region 531 and the third region 533. The step portion 537 may come into contact with the outer surface 503s of the member (lid member 503).

In this manner, the step portion 537 comes into contact with the outer surface of the member (lid member 503). Therefore, it becomes easier to perform positioning when the fuel pipe 530 is attached to the member (lid member 503).

In the gas turbine combustor 100 illustrated in FIG. 6C, the second region 532 may be located on the downstream side (axial downstream side) of the fuel pipe 530 (F21 system fuel pipe 5321) with respect to the third region 533. That is, in the gas turbine combustor 100 illustrated in FIG. 6C, in the fuel pipe 530 (F21 system fuel pipe 5321), the first region 531, the third region 533, and the second region 532 are disposed from the upstream side toward the downstream side in this order.

In this manner, the second region 532 fitted to the through-hole 505 in the member (lid member 503) is located on the downstream side of the fuel pipe 530 with respect to the third region 533. Therefore, in the region on the downstream side in the third region 533, a possibility that a gap between the outer peripheral surface 533a of the third region 533 and the inner peripheral surface 505a of the through-hole 505 varies depending on a position in the circumferential direction is suppressed.

In the gas turbine combustor 100 illustrated in FIGS. 6A, 6B, and 6C, the first outer diameter d1 of the first region 531 may be larger than the second outer diameter d2 of the second region 532. The second outer diameter d2 of the second region 532 may be larger than the third outer diameter d3 of the third region 533.

In this manner, the outer diameter of each region can be easily set by processing an outer periphery of the fuel pipe 530 (F21 system fuel pipe 5321).

In the gas turbine combustor 100 illustrated in FIGS. 6A and 6B, the F22 system fuel pipe 5322 may have the same configuration as that of the F21 system fuel pipe 5321 described above.

In the gas turbine combustor 100 illustrated in FIGS. 6A and 6B, a length L3 of the third region 533 along the axial direction of the fuel pipe 530 (F21 system fuel pipe 5321) may be longer than a length L2 of the second region 532 along the axial direction.

Since the length L3 of the third region 533 along the axial direction is longer than the length L2 of the second region 532 along the axial direction, it is possible to increase the axial length of the empty space 504 functioning as a heat shield layer between the outer peripheral surface 533a of the third region 533 and the inner peripheral surface 505a of the through-hole 505. In this manner, the member (lid member 503) is less likely to be locally cooled by the fuel. Therefore, the thermal stress of the member (lid member 503) can be effectively reduced.

In the gas turbine combustor 100 illustrated in FIGS. 6A and 6B, the F22 system fuel pipe 5322 may have the same configuration as that of the F21 system fuel pipe 5321 described above.

In the gas turbine combustor 100 according to some embodiments, the fuel pipe 530 may include the F21 system fuel pipe 5321 serving as a first fuel pipe 530A, and the F22 system fuel pipe 5322 serving as a second fuel pipe 530B different from the first fuel pipe 530A (refer to FIG. 5). During the partial load operation of the gas turbine combustor 100, the fuel may circulate through the first fuel pipe 530A (F21 system fuel pipe 5321), and the fuel may not circulate through the second fuel pipe 530B (F22 system fuel pipe 5322). During the rated load operation of the gas turbine combustor 100, the fuel may circulate through the first fuel pipe 530A (F21 system fuel pipe 5321) and the second fuel pipe 530B (F22 system fuel pipe 5322).

As described above, in the gas turbine combustor 100 according to some embodiments, during the partial load operation, the combustion air may be caused to circulate through the second fuel pipe 530B (F22 system fuel pipe 5322) through which the fuel does not circulate. Therefore, the high-pressure air 120 having a relatively higher temperature flows into the fuel cavity 510 (F22 system fuel cavity 5122) to which the second fuel pipe 530B (F22 system fuel pipe 5322) is connected. Therefore, the temperature of the fuel cavity forming portion 501 or of the lid member 503, which is the member that partitions the fuel cavity 510, is likely to become relatively higher.

According to the gas turbine combustor 100 according to some embodiments, when at least the first fuel pipe 530A (F21 system fuel pipe 5321) has the above-described third region 533, the lid member 503, which is the member to which the first fuel pipe 530A (F21 system fuel pipe 5321) is connected, is less likely to be locally cooled by the fuel. Therefore, the thermal stress of the member can be reduced.

In the gas turbine combustor 100 according to some embodiments, the burner 3 to which the fuel is supplied by the fuel pipe 530 (F21 system fuel pipe 5321) may be the main burner 3A.

When the partial load operation is performed or the rated load operation is performed by the gas turbine combustor 100, combustion in a part of the main burner 3A is stopped during the partial load operation. In this case, as described above, only the high-pressure air 120 may be ejected from a portion of the main burner 3A in which the fuel is stopped. In this case, the high-pressure air 120 having a relatively higher temperature flows into the fuel cavity 510 communicating with the portion of the main burner 3A. Therefore, the temperature of the member that partitions the fuel cavity 510 is likely to become relatively higher.

According to the gas turbine combustor 100 in some embodiments, when the F21 system fuel pipe 5321, which is the fuel pipe 530 configured to supply the fuel to the main burner 3A other than the above-described portion of the main burner 3A, has the above-described third region 533, the member (lid member 503) to which the fuel pipe 530 is connected is less likely to be locally cooled by the fuel. Therefore, the thermal stress of the member can be reduced.

In the gas turbine combustor 100 according to some embodiments, the second region 532 may extend along the axial direction of the gas turbine combustor 100. As illustrated in FIGS. 3 to 5, the first region 531 may extend to face outward in the radial direction of the gas turbine combustor 100 as the first region 531 faces the upstream side in at least some regions.

In this manner, the fuel pipe 530 extends outward in the radial direction of the gas turbine combustor 100 as the fuel pipe 530 faces the upstream side outside the gas turbine combustor 100. Therefore, the fuel pipe 530 is less likely to interfere with other members such as the other fuel pipe 530.

In the gas turbine combustor 100 illustrated in FIGS. 6A and 6B, the fuel pipe 530 may be connected to the member (lid member 503) by a welding portion 507. As in the gas turbine combustor 100 illustrated in FIG. 6B, the fuel pipe 530 may come into contact with molten metal 508 of the welding portion 507, and may include a fourth region 534 having a fourth outer diameter d4 larger than the first outer diameter d1 of the first region 531.

In this manner, compared to when the fourth region 534 is not included, the amount of the molten metal in the welding portion 507 can be increased, and bonding strength between the fuel pipe 530 and the member (lid member 503) can be improved.

In the gas turbine combustor 100 illustrated in FIGS. 6A and 6B, the F22 system fuel pipe 5322 may have the same configuration as that of the F21 system fuel pipe 5321 described above.

In the gas turbine combustor 100 according to some embodiments, the fuel may be a gas fuel.

In this manner, compared to when the fuel is a liquid fuel, a heat transfer coefficient between the fuel pipe 530 and the fuel is lowered, and the fuel pipe 530 is less likely to be cooled. Therefore, the thermal stress of the lid member 503 can be reduced.

In the gas turbine combustor 100 according to some embodiments, the fuel pipe 530 may include at least the F21 system fuel pipe 5321 serving as the first fuel pipe 530A and the F22 system fuel pipe 5322 serving as the second fuel pipe 530B different from the first fuel pipe 530A. For example, as illustrated in FIG. 4, the first fuel pipe 530A (F21 system fuel pipe 5321) and the second fuel pipe 530B (F22 system fuel pipe 5322) may be disposed at positions displaced by 180 degrees around the central axis AXc of the gas turbine combustor 100.

The present disclosure is not limited to the above-described embodiments, and also includes a form in which modifications are added to the above-described embodiments or a form in which the embodiments are combined with each other as appropriate.

For example, in some of the above-described embodiments, the burner 3 is the cluster burner, but may be a general premixed burner or a diffusion combustion type burner.

In addition, the F21 system fuel pipe 5321 and the F22 system fuel pipe 5322 may be directly attached to the fuel cavity forming portion 501 instead of to the lid member 503.

For example, contents described in each of the above-described embodiments are understood as follows.

(1) According to at least one embodiment of the present disclosure, there is provided the gas turbine combustor 100. The gas turbine combustor includes the burner 3, and the fuel pipe 530 that supplies the fuel to the burner 3. The fuel pipe 530 is connected to the lid member 503, which is the member that partitions at least a portion of the fuel cavity 510 and the outside of the gas turbine combustor 100. The fuel pipe 530 (F21 system fuel pipe 5321) includes the first region 531 located on the upstream side of the member (lid member 503), the second region 532 formed in the member (lid member 503) and fitted to the through-hole 505 through which the outside and the fuel cavity 510 (F21 system fuel cavity 5121) communicate with each other, and the third region 533 having the outer peripheral surface 533a separated inward in the radial direction from the inner peripheral surface 505a of the through-hole 505. A downstream end 530de of the fuel pipe 530 (F21 system fuel pipe 5321) reaches an end portion 505de closer to the fuel cavity 510 in both end portions of the through-hole 505.

According to a configuration of (1) above, the outer peripheral surface 533a of the third region 533 is separated inward in the radial direction from the inner peripheral surface 505a of the through-hole 505 formed in the member (lid member 503). Therefore, the empty space 504 between the outer peripheral surface 533a of the third region 533 and the inner peripheral surface 505a of the through-hole 505 functions as the heat shield layer. In this manner, compared to when the outer peripheral surface 533a of the third region 533 is in contact with the inner peripheral surface 505a of the through-hole 505, the member (lid member 503) is less likely to be locally cooled by the fuel, and thermal stress of the member (lid member 503) can be reduced. In addition, the downstream end 530de of the fuel pipe 530 (F21 system fuel pipe 5321) reaches the end portion 505de closer to the fuel cavity 510 in the through-hole 505. Therefore, a possibility that the fuel is locally cooled by directly coming into contact with the member (lid member 503) inside the through-hole 505 is suppressed, and the thermal stress of the member (lid member 503) can be reduced.

Therefore, according to the configuration of (1) above, the durability of the gas turbine combustor 100 can be improved.

(2) In some embodiments, in the configuration of (1) above, the first outer diameter d1 of the first region 531 may be larger than the second outer diameter d2 of the second region 532. The fuel pipe 530 may have a step portion 535 formed by a difference between the first outer diameter d1 and the second outer diameter d2 at a boundary portion between the first region 531 and the second region 532. The step portion 535 may come into contact with an outer surface 503s of the member (lid member 503).

According to a configuration of (2) above, the step portion 535 comes into contact with the outer surface 503s of the member (lid member 503), and the second region 532 is fitted to the through-hole 505 as in the configuration of (1) above. Therefore, the fuel pipe 530 (F21 system fuel pipe 5321) and the member (lid member 503) are fitted in a spigot joint manner. In this manner, it becomes easier to perform positioning when the fuel pipe 530 (F21 system fuel pipe 5321) is attached to the member (lid member 503). In addition, a position of the through-hole 505 in the radial direction inside the through-hole 505 of the third region 533 is determined by the fitting in the spigot joint manner. Therefore, a possibility that a gap between the outer peripheral surface 533a of the third region 533 and the inner peripheral surface 505a of the through-hole 505 varies depending on a position in the circumferential direction is suppressed.

(3) In some embodiments, in the configuration of (1) or (2) above, the third region 533 may be located on the downstream side (axial downstream side) of the fuel pipe 530 (F21 system fuel pipe 5321) with respect to the second region 532.

According to a configuration of (3) above, compared to when the third region 533 is located on the upstream side of the fuel pipe 530 (F21 system fuel pipe 5321) with respect to the second region 532, the position of the third region 533 is closer to the fuel cavity 510. Therefore, the region relatively closer to the fuel cavity 510 in the member (lid member 503) is less likely to be cooled by the fuel.

The member (lid member 503) partitions at least a portion of the fuel cavity 510 and the outside of the gas turbine combustor 100. Therefore, a region closer to the fuel cavity 510 tends to have a higher temperature than a region farther from the fuel cavity 510. That is, in the member (lid member 503), the region on the downstream side of the fuel pipe 530 (F21 system fuel pipe 5321) tends to have a higher temperature than the region on the upstream side. Therefore, according to the configuration of (3) above, as described above, the region relatively closer to the fuel cavity 510 in the member is less likely to be locally cooled by the fuel. Therefore, the thermal stress of the member (lid member 503) can be effectively reduced.

(4) In some embodiments, in the configuration of (1) above, the first outer diameter d1 of the first region 531 may be larger than the third outer diameter d3 of the third region 533. The fuel pipe 530 may have the step portion 537 formed by the difference between the first outer diameter d1 and the third outer diameter d3 at the boundary portion between the first region 531 and the third region 533. The step portion 537 may come into contact with the outer surface 503s of the member (lid member 503).

According to a configuration of (4) above, the step portion 537 comes into contact with the outer surface of the member (lid member 503). Therefore, it becomes easier to perform positioning when the fuel pipe 530 is attached to the member (lid member 503).

(5) In some embodiments, in the configuration (1) or (4) above, the second region may be located on the downstream side of the fuel pipe with respect to the third region.

According to a configuration of (5) above, the second region 532 fitted to the through-hole 505 in the member (lid member 503) is located on the downstream side of the fuel pipe 530 with respect to the third region 533. Therefore, in the region on the downstream side of the third region 533, a possibility that a gap between the outer peripheral surface 533a of the third region 533 and the inner peripheral surface 505a of the through-hole 505 varies depending on a position in the circumferential direction is suppressed.

(6) In some embodiments, in any of the configurations (1) to (5) above, the first outer diameter d1 of the first region 531 may be larger than the second outer diameter d2 of the second region 532. The second outer diameter d2 of the second region 532 may be larger than the third outer diameter d3 of the third region 533.

According to a configuration (6) above, the outer diameter of each region can be easily set by processing the outer periphery of the fuel pipe 530 (F21 system fuel pipe 5321).

(7) In some embodiments, in any of the configurations (1) to (6) above, the length L3 of the third region 533 along the axial direction of the fuel pipe 530 (F21 system fuel pipe 5321) may be longer than the length L2 of the second region 532 along the axial direction.

According to a configuration of (7) above, the length L3 of the third region 533 along the axial direction is set to be longer than the length L2 of the second region 532 along the axial direction. Therefore, it is possible to increase the axial length of the empty space 504 functioning as the heat shield layer between the outer peripheral surface 533a of the third region 533 and the inner peripheral surface 505a of the through-hole 505. In this manner, the member (lid member 503) is less likely to be locally cooled by the fuel. Therefore, the thermal stress of the member (lid member 503) can be effectively reduced.

(8) In some embodiments, in any of the configurations (1) to (7) above, the fuel pipe 530 may include the first fuel pipe 530A (F21 system fuel pipe 5321) and the second fuel pipe 530B (F22 system fuel pipe 5322) different from the first fuel pipe 530A. During the partial load operation of the gas turbine combustor 100, the fuel may circulate through the first fuel pipe 530A (F21 system fuel pipe 5321), and the fuel may not circulate through the second fuel pipe 530B (F22 system fuel pipe 5322). During the rated load operation of the gas turbine combustor 100, the fuel may circulate through the first fuel pipe 530A (F21 system fuel pipe 5321) and the second fuel pipe 530B (F22 system fuel pipe 5322).

During the partial load operation, the combustion air may be caused to circulate through the second fuel pipe 530B (F22 system fuel pipe 5322) through which the fuel does not circulate. Therefore, the combustion air (high-pressure air 120) having a relatively higher temperature flows into the fuel cavity 510 (F22 system fuel cavity 5122) to which the second fuel pipe 530B (F22 system fuel pipe 5322) is connected. Therefore, the temperature of the fuel cavity forming portion 501 or of the lid member 503, which is the member that partitions the fuel cavity 510, is likely to become relatively higher.

According to a configuration of (8) above, when at least the first fuel pipe 530A (F21 system fuel pipe 5321) has the above-described third region 533, the lid member 503, which is the member to which the first fuel pipe 530A (F21 system fuel pipe 5321) is connected, is less likely to be locally cooled by the fuel. Therefore, the thermal stress of the member can be reduced.

(9) In some embodiments, in any of the configurations (1) to (8) above, the burner 3 may be the main burner 3A.

When the partial load operation is performed or the rated load operation is performed by the gas turbine combustor 100, combustion in a part of the main burner 3A is stopped during the partial load operation. In this case, only the combustion air (high-pressure air 120) may be ejected from a portion of the main burner 3A in which the fuel is stopped. In this case, the combustion air (high-pressure air 120) having a relatively higher temperature flows into the fuel cavity 510 communicating with the portion of the main burner 3A. Therefore, the temperature of the member that partitions the fuel cavity 510 is likely to become relatively higher.

According to a configuration of (9) above, when the fuel pipe 530 configured to supply the fuel to the main burner 3A other than the above-described portion of the main burner 3A has the above-described third region 533, the member (lid member 503) to which the fuel pipe 530 is connected is less likely to be locally cooled by the fuel. Therefore, the thermal stress of the member can be reduced.

(10) In some embodiments, in any of the configurations of (1) to (9) above, the second region 532 may extend along the axial direction of the gas turbine combustor 100. The first region 531 may extend outward in the radial direction of the gas turbine combustor 100 as the first region 531 faces the upstream side in at least some regions.

According to a configuration of (10) above, the fuel pipe 530 extends outward in the radial direction of the gas turbine combustor 100 as the fuel pipe 530 faces the upstream side outside the gas turbine combustor 100. Therefore, the fuel pipe 530 is less likely to interfere with other members such as the other fuel pipe 530.

(11) In some embodiments, in any of the configurations of (1) to (10) above, the fuel pipe 530 may be connected to the member (lid member 503) by the welding portion 507. The fuel pipe 530 may come into contact with the molten metal of the welding portion 507, and may include the fourth region 534 having the fourth outer diameter d4 larger than the first outer diameter d1 of the first region 531.

According to a configuration of (11) above, compared to when the fourth region 534 is not included, the amount of the molten metal in the welding portion 507 can be increased, and bonding strength between the fuel pipe 530 and the member (lid member 503) can be improved.

(12) In some embodiments, in any of the configurations of (1) to (11) above, the fuel may be the gas fuel.

According to a configuration of (12) above, compared to when the fuel is the liquid fuel, the heat transfer coefficient between the fuel pipe 530 and the fuel is lowered, and the fuel pipe 530 is less likely to be cooled. Therefore, the thermal stress of the member (lid member 503) can be reduced.

(13) In some embodiments, in any of the configurations of (1) to (12) above, the fuel pipe 530 may include at least the F21 system fuel pipe 5321 serving as the first fuel pipe 530A and the F22 system fuel pipe 5322 serving as the second fuel pipe 530B different from the first fuel pipe 530A. The first fuel pipe 530A (F21 system fuel pipe 5321) and the second fuel pipe 530B (F22 system fuel pipe 5322) may be disposed at positions displaced by 180 degrees with respect to the central axis AXc of the gas turbine combustor 100.

According to a configuration of (13) above, the first fuel pipe 530A (F21 system fuel pipe 5321) and the second fuel pipe 530B (F22 system fuel pipe 5322) may be disposed at positions displaced by 180 degrees around the central axis of the gas turbine combustor.

(14) According to at least one embodiment of the present disclosure, there is provided the gas turbine 1 including the gas turbine combustor 100 having the configuration according to any one of (1) to (13) above.

According to a configuration of (14) above, the thermal stress of the member (lid member 503) can be reduced, and the durability of the gas turbine combustor 100 can be improved. Therefore, the reliability of the gas turbine 1 can be improved.

### REFERENCE SIGNS LIST

1: Gas turbine
3: Burner
3A: Main burner
3B: Pilot burner
31, 32: Fuel nozzle
33: Air hole plate
100: Gas turbine combustor
500: End cover
503: Lid member
503a: Surface
505: Through-hole
510: Fuel cavity
530: Fuel pipe
530A: First fuel pipe
530B: Second fuel pipe
531: First region
532: Second region
533: Third region
534: Fourth region
535: Step portion

1. A gas turbine combustor comprising:
a burner; and
a fuel pipe that supplies a fuel to the burner,
wherein the fuel pipe is connected to a member that partitions at least a portion of a fuel cavity and an outside of the gas turbine combustor, and includes a first region located on an upstream side of the member, a second region formed in the member and fitted to a through-hole through which the outside and the fuel cavity communicate with each other, and a third region having an outer peripheral surface separated inward in a radial direction from an inner peripheral surface of the through-hole, and
a downstream end of the fuel pipe reaches an end portion closer to the fuel cavity out of both end portions of the through-hole.

2. The gas turbine combustor according to claim 1,
wherein a first outer diameter of the first region is larger than a second outer diameter of the second region,
the fuel pipe has a step portion formed by a difference between the first outer diameter and the second outer diameter at a boundary portion between the first region and the second region, and
the step portion comes into contact with an outer surface of the member.

3. The gas turbine combustor according to claim 1,
wherein the third region is located on a downstream side of the fuel pipe with respect to the second region.

4. The gas turbine combustor according to claim 1,
wherein a first outer diameter of the first region is larger than a third outer diameter of the third region,
the fuel pipe has a step portion formed by a difference between the first outer diameter and the third outer diameter at a boundary portion between the first region and the third region, and
the step portion comes into contact with an outer surface of the member.

5. The gas turbine combustor according to claim 1,
wherein the second region is located on a downstream side of the fuel pipe with respect to the third region.

6. The gas turbine combustor according to claim 1,
wherein a first outer diameter of the first region is larger than a second outer diameter of the second region, and
the second outer diameter of the second region is larger than a third outer diameter of the third region.

7. The gas turbine combustor according to claim 1,
wherein a length of the third region along an axial direction of the fuel pipe is longer than a length of the second region along the axial direction.

8. The gas turbine combustor according to claim 1,
wherein the fuel pipe includes a first fuel pipe and a second fuel pipe different from the first fuel pipe,
during a partial load operation of the gas turbine combustor, the fuel circulates through the first fuel pipe, and the fuel does not circulate through the second fuel pipe, and
during a rated load operation of the gas turbine combustor, the fuel circulates through the first fuel pipe and the second fuel pipe.

9. The gas turbine combustor according to claim 1,
wherein the burner is a main burner.

10. The gas turbine combustor according to claim 1,
wherein the second region extends along an axial direction of the gas turbine combustor, and
the first region extends outward in a radial direction of the gas turbine combustor as the first region faces an upstream side in at least some regions.

11. The gas turbine combustor according to claim 1,
wherein the fuel pipe is connected to the member by a welding portion, comes into contact with molten metal of the welding portion, and includes a fourth region having a fourth outer diameter larger than a first outer diameter of the first region.

12. The gas turbine combustor according to claim 1,
wherein the fuel is a gas fuel.

13. The gas turbine combustor according to claim 1,
wherein the fuel pipe includes at least a first fuel pipe and a second fuel pipe different from the first fuel pipe, and
the first fuel pipe and the second fuel pipe are disposed at positions displaced by 180 degrees around a central axis of the gas turbine combustor.

14. A gas turbine comprising:
the gas turbine combustor according to claim 1.
